(19) United States
(12) Patent Application Publication
(10) Pub. No.: US 2006/0071561 A1
(43) Pub. Date: Apr. 6, 2006

(54) Electromagnetic power device

(76) Inventors: Chi-Ming Chiu, Taipei Hsien (TW); I-Min Chang, Taipei City (TW)

Correspondence Address: BACON & THOMAS, PLLC, 625 SLATERS LANE, FOURTH FLOOR, ALEXANDRIA, VA, 22314, US

(21) Appl. No.: 11/225,026

(22) Filed: Sep. 14, 2005

(30) Foreign Application Priority Data
Oct. 4, 2004 (TW) 093130186

(51) Int. Cl. H02K 33/00

(52) U.S. Cl. 310/20; 310/35; 310/34

(57) ABSTRACT

An electromagnetic power device includes a base forming a guide section, a stator on which an electromagnet is mounted, a mover that is guided by the guide section to reciprocally and linearly move and carrying a permanent magnet, a crankshaft to which the mover is coupled by a link, and a control unit electrically coupled to the electromagnet to energize the electromagnet in a controlled manner whereby the electromagnet generates a variable magnetic field that interacts with a fixed magnetic field of the permanent magnet to move the movers toward/away from the stator. The linear movement of the mover is converted into rotary motion of the crankshaft by the link.

### BACKGROUND OF THE INVENTION

1. Field of the Invention

The present invention relates to an electromagnetic power device comprising a fixed magnetic field and a variable magnetic field that react with each other to drive a crank-slide mechanism for converting linear motion into rotary motion.

2. Prior Arts

A conventional engine uses expansion of air caused by combustion of fuel in a cylinder to reciprocally and linearly move a piston in the cylinder. A crank-slide mechanism converts the linear motion of the piston into rotary power that drives other machines. Due to the oil crisis, energy sources that are alternative to the fossil fuel are being developed to replace the lacking fossil fuel. Most the currently available new form of energy are converted into electricity first before they can be utilized to drive other machines that are driven by rotary power via for example an electrical motor. However, the electrical motor that are commonly used nowadays is very bulky and of great weight, and has poor power conversion efficiency.

Thus, the present invention is aimed to overcome the drawbacks of the conventional rotary power device.

### SUMMARY OF THE INVENTION

Thus, an objective of the present invention is to provide an electromagnetic power device that overcomes, or at least alleviates, at least one of the drawbacks of the conventional rotary power device.

Another objective of the present invention is to provide an electromagnetic power device that comprises a fixed magnetic field and a variable magnetic field reacting with each to generate rotary power by making direct use of electricity.

Another objective of the present invention is to provide an electromagnetic power device for replacing the conventional internal combustion engine while still compatible with the conventional transmission system.

In accordance with the present invention, to realize the above objectives, an electromagnetic power device comprises a base forming a guide section, a stator on which an electromagnet is mounted, a mover that is guided by the guide section to reciprocally and linearly move and carrying a permanent magnet, a crankshaft to which the mover is coupled by a link, and a control unit electrically coupled to the electromagnet to energize the electromagnet in a controlled manner whereby the electromagnet generates a variable magnetic field that interacts with a fixed magnetic field of the permanent magnet to move the movers toward/away from the stator. The linear movement of the mover is converted into rotary motion of the crankshaft by the link.

The present invention will become more obvious from the following description when taken in connection with the accompanying drawings, which show, for purposes of illustration only, preferred embodiments in accordance with the present invention.

### BRIEF DESCRIPTION OF THE DRAWINGS

FIG. 1 is a schematic cross-sectional view showing an electromagnetic power device constructed in accordance with a first embodiment of the present invention;

FIG. 2 is a schematic view showing the operation of the electromagnetic power device in accordance with the first embodiment of the present invention;

FIG. 3 is a schematic cross-sectional view showing an electromagnetic power device constructed in accordance with a second embodiment of the present invention;

FIG. 4 is a schematic cross-sectional view showing an electromagnetic power device constructed in accordance with a third embodiment of the present invention;

FIG. 5 is a schematic view showing an electromagnetic power device constructed in accordance with a fourth embodiment of the present invention;

FIG. 6 is a schematic view showing an electromagnetic power device constructed in accordance with a fifth embodiment of the present invention;

FIG. 7 is a schematic view showing an electromagnetic power device constructed in accordance with a sixth embodiment of the present invention;

FIG. 8 is a schematic view showing an electromagnetic power device constructed in accordance with a seventh embodiment of the present invention;

FIG. 9 is a top view of a rotary disk of the electromagnetic power device of the present invention;

FIG. 10 is a schematic view showing an electromagnetic power device constructed in accordance with an eighth embodiment of the present invention; and

FIG. 11 is a top view of a rotary disk of the electromagnetic power device of the present invention.

### DETAILED DESCRIPTION OF THE PREFERRED EMBODIMENT

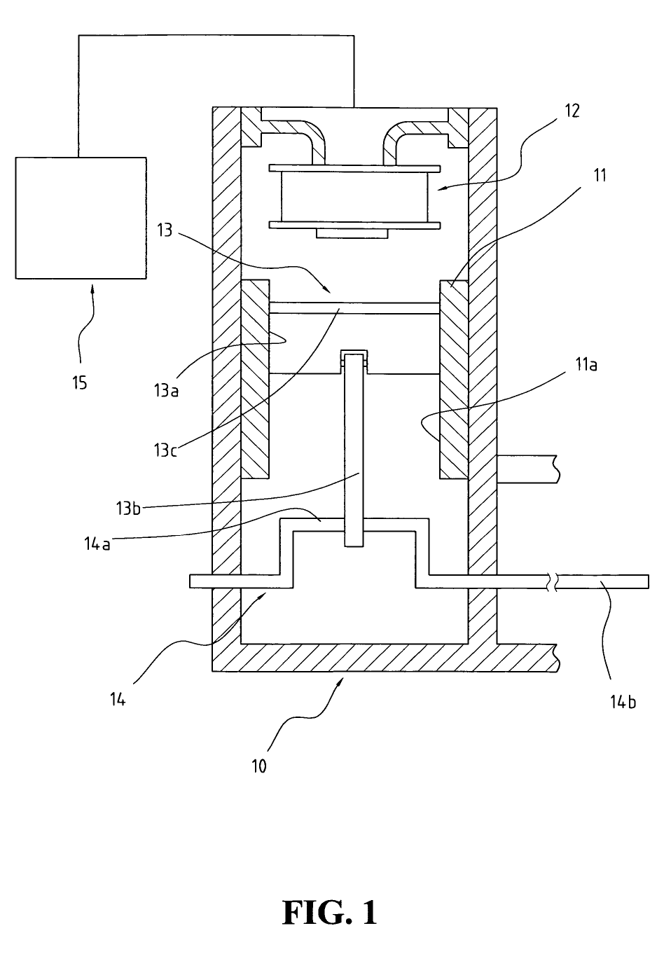

Referring to the drawings and in particular to FIG. 1, an electromagnetic power device constructed in accordance with a first embodiment of the present invention comprises a base 10, a stator 12, a reciprocation mechanism 13, a crankshaft 14, and a control unit 15. The base 10 has a hollow construction forming a guide section 11 for guiding reciprocation of the reciprocation mechanism 13. The stator 12 is arranged above the guide section 11 of the base 10 and comprises an electrical coil connected to the control unit 15 by which electrical power is supplied to the coil in order to induce a magnetic field in a vertical direction.

The reciprocation mechanism 13 comprises a mover 13a having an underside pivoted to a link 13b. The mover 13a is movably received in the guide section 11 of the base 10 for linearly moving along the guide section 11. The guide section 11 may be cylindrical and surrounding the mover 13a. A permanent magnet 13c is fixed atop the mover 13a, which reacts with the magnetic field generated by the stator 12 to generate a force for driving the mover 13a.

The crankshaft 14 is rotatably mounted to the base 10 under the guide section 11, and forming a U-shaped crank section 14a, of which an end forms a power output shaft 14b. The link 13b of the mover 13a is rotatably attached to the crank section 14a of the crankshaft 14 for converting the linear motion of the mover 13 into rotary motion of the output shaft 14b.

The control unit 15 supplies electrical power to the coil of the stator 12 for the generation and controlling of the magnetic field from the coil of the stator 12.

The guide section 11 comprises a linear chute or sliding channel 11a in which the mover 13 is accommodated whereby the mover 13a moves reciprocally and linearly on and along the sliding channel 11.

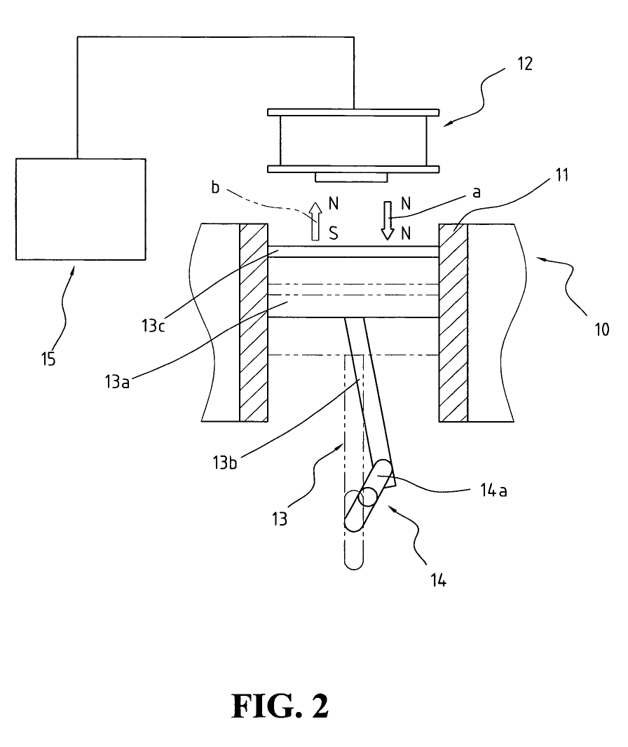

Also referring to FIG. 2, the mover 13a of the reciprocation mechanism 13 that is allowed to move up and down under the guidance of the guide section 11 of the base 10 and the crank section 14a of the crankshaft 14 that is linked to the mover 13a by the link 13b constitute, together, a crank-slide mechanism. When the control unit 15 supplies electrical power to the stator 12, the stator 12 generates a magnetic field, which acts on the permanent magnet 13c atop the mover 13a to induce a force for driving the mover 13a. For example, if the stator 12 generates a magnetic field having an N-pole heading down, while the permanent magnet 13c of the mover 13a has an N-pole pointing upward, then a repulsive force is induced and acting on the mover 13a, as indicated by arrow a of FIG. 2, which drives the mover 13a in a downward direction away from the stator 12. If the stator 12 generates a magnetic field having an S-pole heading down, while the permanent magnet 13c of the mover 13a has an N-pole pointing upward, then an attractive force is induced and acting on the mover 13a, as indicated by arrow b of FIG. 2, which drives the mover 13a in an upward direction toward the stator 12.

The control unit 15 supplies electrical power to the stator 12 in a controlled manner whereby the stator 12 generates a magnetic field of which the orientation is reversed cyclically to alternatively induce repulsive force and attractive force on the mover 13. Thus, the mover 13 is driven reciprocally and cyclically. The cyclical reciprocation of the mover 13 is transmitted to the crank section 14 of the crankshaft 14 by the link 13b by which the linear motion of the mover 13 is converted into rotary power of the crankshaft 14, which can be supplied to an external machine by the output shaft 14b.

Modifications of the above arrangement can be apparent to those having ordinary skills in the art. For example, the permanent magnet 13c of the mover 13a may be replaced by a coil that receives electrical power from the control unit 15 to generate a variable magnetic field of which the orientation is opposite to that of the coil of the mover 13. Or, alternatively, under the condition that the mover 13a is provided with a variable magnet that is controlled by the control unit 15 or a similar device, the coil of the stator 12 may be replaced by a permanent magnet, which generates a fixed magnetic field to interact with the variable magnetic field of the coil of the mover 13.

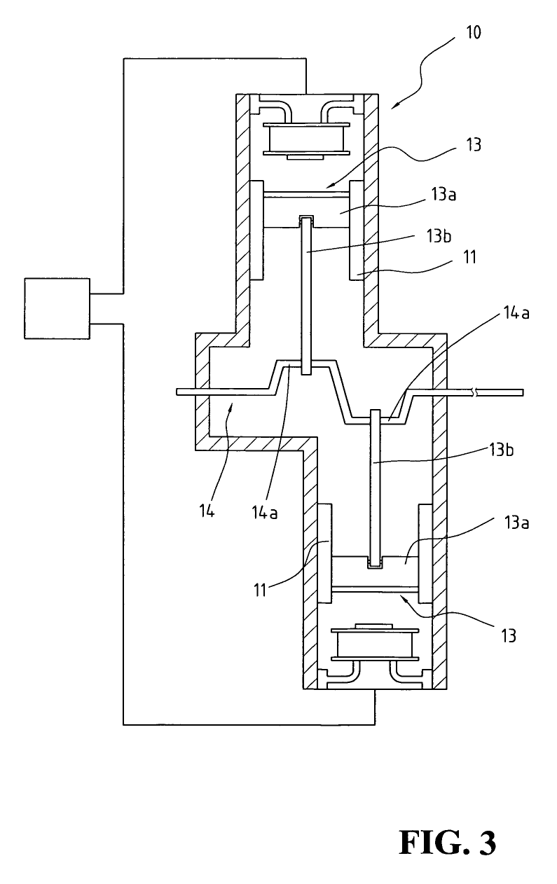

With reference to FIG. 3, which shows an electromagnetic power device in accordance with a second embodiment of the present invention, the second embodiment electromagnetic power device comprises a plurality of identical or similar reciprocation mechanisms 13, which is identical to that described with reference to FIGS. 1 and 2. In the embodiment illustrated, two reciprocation mechanisms 13 are contained in the hollow base 10 and each is associated with a stator 12 and is coupled to a respective crank section 14a of the crankshaft 14 by a respective link 13b. In the embodiment illustrated, the two sets of reciprocation mechanism 13 are arranged on the same horizontal plane and on opposite sides of the crankshaft 14. The base 10 forms two guide sections 11 each corresponding to each crank section 14 of the crankshaft 14 and accommodating and slidably guiding the linear and reciprocal movement of the respective mover 13a. The stators 12 are arranged to respectively oppose the guide sections 11 and facing the movers 13a that are coupled by the respective links 13b to the crank sections 14a of the crankshaft 14. Thus, each reciprocation mechanism 13 and the associated stator 12 and crank section 14 form an mechanical arrangement that is identical to that of the first embodiment.

Due to the similarity between the two sets of reciprocation mechanism 13, the reciprocation of the movers 13a are the same. Thus, the relative angular positions of the movers 13a with respect to the crankshaft 14 must be arranged to have an initial configuration that allows the movers 13 to sequentially rotate the crankshaft 14, rather than counteracting each other.

Preferably, the movers 13a and the reciprocation mechanisms 13 are uniformly arranged around the crankshaft 14 by equal angular displacement, which smoothens the rotation of the crankshaft 14 induced by the driving force of the movers 13a. For example and as illustrated in FIG. 3, the two movers 13a are angularly offset with respect to each other by an angle of 180 degrees whereby the crank sections 14 are also oriented to angularly offset with respect to each other by 180 degrees.

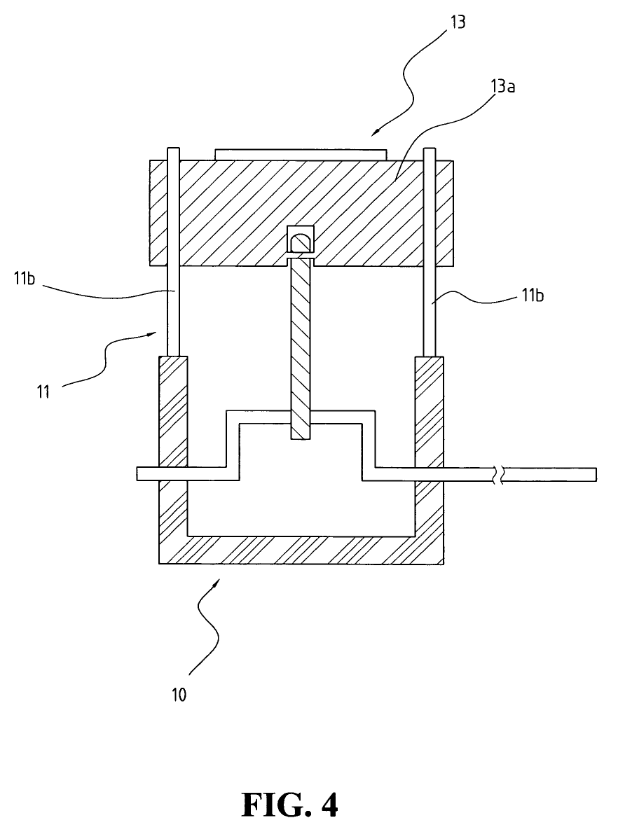

Referring to FIG. 4, which shows an electromagnetic power device constructed in accordance with a third embodiment of the present invention, the third embodiment electromagnetic power device comprises a base 10 forms a guide section 11 comprised of straight posts 11b slidably extending through holes (not labeled) defined in the mover 13a of the reciprocation mechanism 13 for guiding linear movement of the mover 13a. The number of the posts 11bs is not subject to any constraints. For example and as illustrated in FIG. 4, two guide posts 11b extend from the base 10 and respectively through two holes (not labeled) defined in the mover 13a. Thus, the mover 13a is movable along the posts 11b. As compared to the first and second embodiments, the contact area between the movers 13a and the guide posts 11b is much smaller than that between the movers 13a and the guide section 11 surrounding the mover 13a. Thus, the friction between the mover 13a and the guide posts 11b is reduced, which facilitates movement of the mover 13a along the posts 11b.

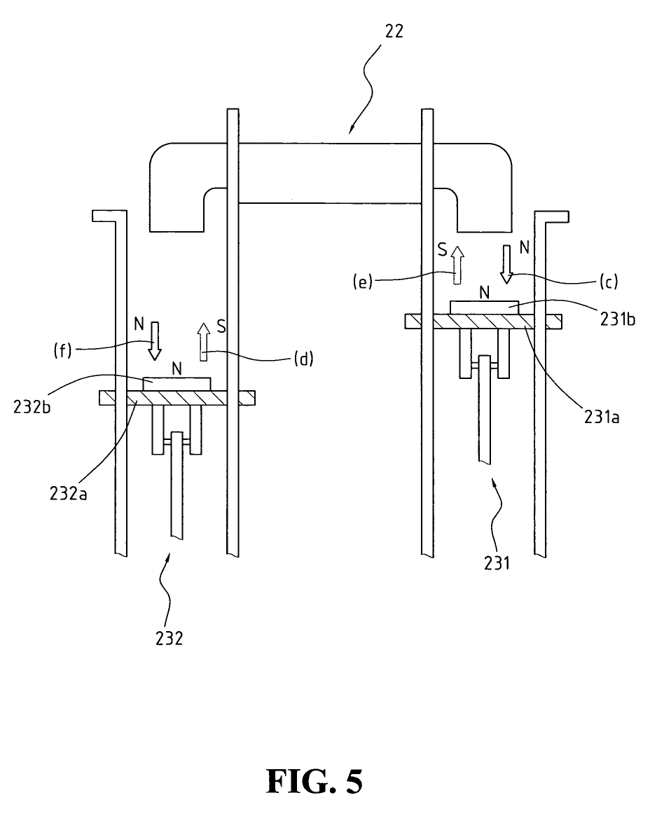

Referring to FIG. 5, which shows an electromagnetic power device constructed in accordance with a fourth embodiment of the present invention, the fourth embodiment electromagnetic power device comprises a stator 22 to which a coil that generates a variable magnetic field is mounted. The coil is arranged so that magnetic poles are spaced from each other. In other words, the N-pole and S-pole are respectively induced at portions of the coil that are spaced from each other. The fourth embodiment electromagnetic power device also comprises first and second reciprocation mechanisms 231, 232 respectively opposing the portions of the coils on which the N-pole and S-pole are induced. The first and second reciprocation mechanisms 231, 232 comprise first and second movers 231a, 232a, atop which permanent magnets 231b, 232b are provided. The permanent magnets 231b, 232b are arranged to have the same orientation. For example, the N-poles of both the magnets 231b, 232b are heading upward. However, the movers 231a, 232a are moved in opposite directions. For example, the initial positions of the first and second movers 231a, 232a are respectively at upper dead center and lower dead center. Thus, when a control unit (not shown) supplies electrical power to the coil of the stator 22, for example, the N-pole is formed in correspondence with the first mover 231a, while the S-pole is formed at the position corresponding to the second movers 232a, as indicated by arrows c and d of FIG. 5, which induces a repulsive force on the first mover 231 and an attractive force on the second mover 232. When the control unit switches the location of the N-pole and S-pole of the stator 22, as indicated by arrows e and f, the repulsion and attraction of the movers 231, 232 are switched, causing the movers 231, 232 in reversed directions. By repeatedly switching N-pole and S-pole of the stator 22, the movers 231, 232 are moved reciprocally in opposite directions. The linear movements of the movers 231, 232 are then converted into rotary power of a crankshaft, which has been described in detail previously and redundant repeat is unnecessary herein.

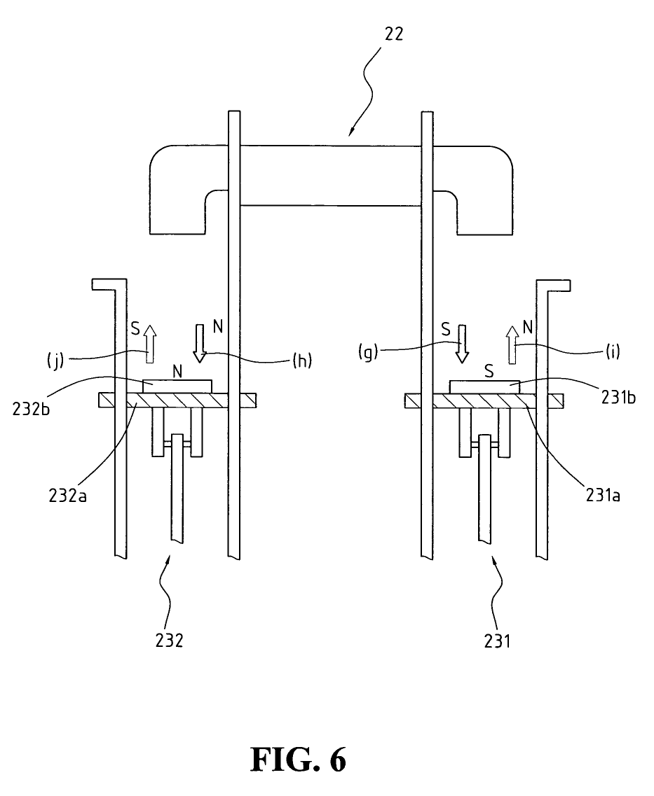

Referring to FIG. 6, which shows an electromagnetic power device constructed in accordance with a fifth embodiment of the present invention, the fifth embodiment electromagnetic power device comprises a stator 22 to which a coil that generates a variable magnetic field is mounted. The coil is arranged so that magnetic poles are spaced from each other. In other words, the N-pole and S-pole are respectively induced at portions of the coil that are spaced from each other. The fifth embodiment electromagnetic power device also comprises first and second reciprocation mechanisms 231, 232 respectively opposing the portions of the coils on which the N-pole and S-pole are induced. The first and second reciprocation mechanisms 231, 232 comprise first and second movers 231a, 232a, atop which permanent magnets 231b, 232b are provided. The permanent magnets 231b, 232b are arranged to have opposite orientations of the magnetic fields thereof. For example, the S-pole of the first magnet 231b and the N-pole of the second magnet 232b are heading upward, while the N-pole of the first magnet 231b and the S-pole of the second magnet 232b are located at lower ends of the magnets 231b, 232b. The movers 231a, 232a are located at corresponding positions and moved in the same directions. For example, when a control unit (not shown) supplies electrical power to the coil of the stator 22, for example, the S-pole is formed in correspondence with the first mover 231a, while the N-pole is formed at the position corresponding to the second movers 232a, as indicated by arrows g and h of FIG. 5, which induces repulsive force on both the first and second movers 231, 232, causing the movers 231, 232 to move away from the stator 22, while when the control unit switches the location of the N-pole and S-pole of the stator 22, as indicated by arrows i and j, both the movers 231, 232 are acted upon by attractive force and the movers 231, 232 move toward the stator 22. By repeatedly switching N-pole and S-pole of the stator 22, the movers 231, 232 are moved reciprocally. The linear movements of the movers 231, 232 are then converted into rotary power of a crankshaft, which has been described in detail previously and redundant repeat is unnecessary herein.

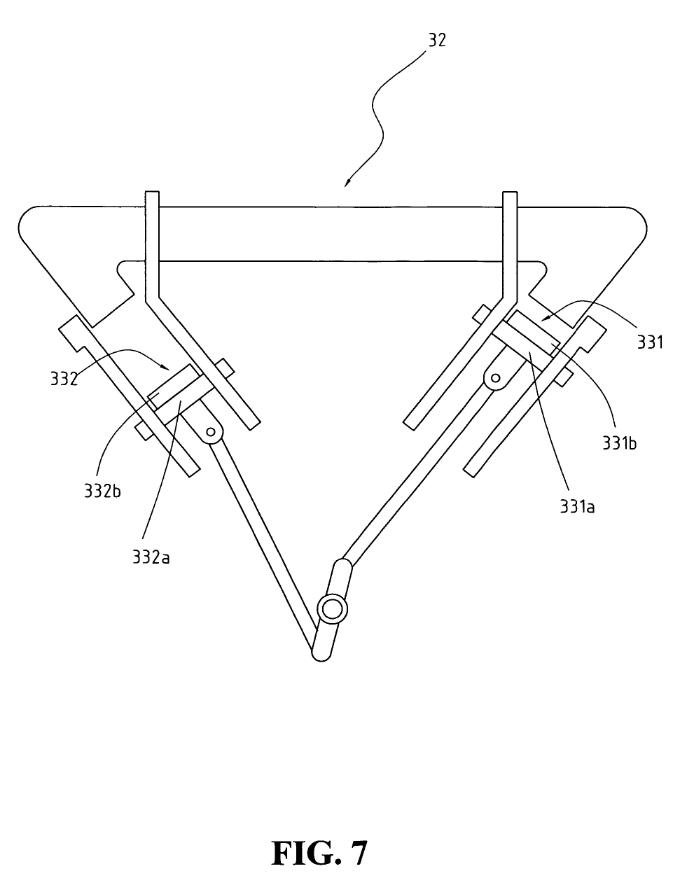

It is noted that the first and second movers 231, 232 of the fourth embodiment or the fifth embodiment are moved in parallel to each other. However, it is apparent to those having ordinary skill to arrange the movers 231, 232 in such a way to allow the first and second movers 231, 232 to move in inclined direction with respect to each other, as shown in FIG. 7 in which a sixth embodiment of the present invention is illustrated. The sixth embodiment electromagnetic power device comprises a stator 32 having portions on which N-pole and S-pole of a variable magnet formed for example a coil are respectively induced. The N-pole and S-pole are arranged to be inclined with respect to a vertical line. The sixth embodiment electromagnetic power device also comprises first and second reciprocation mechanism 331, 332 having first and second movers 331a, 332a atop which first and second magnets 331b, 332b are mounted. The movers 331a, 332a are movable along in directions coaxial with the N-pole and S-pole of the stator 32 and inclined with respect to the vertical line. The movers 331a, 332a can be arranged to move in phase, similar to that illustrated in the fifth embodiment, or out of phase, similar to that illustrated in the fourth embodiment.

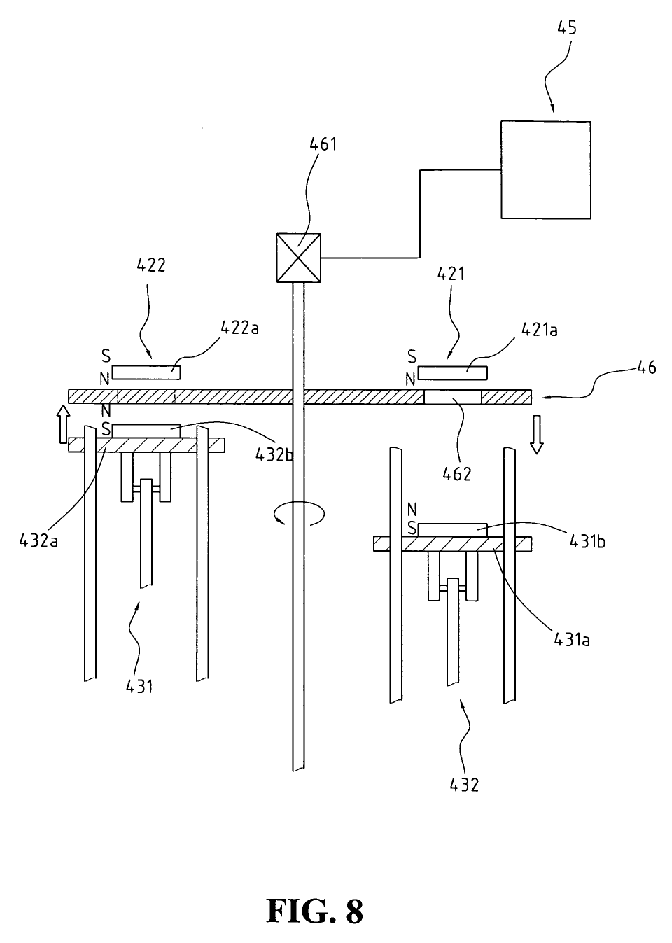

Referring to FIG. 8, which shows an electromagnetic power device constructed in accordance with a seventh embodiment of the present invention, the seventh embodiment comprises a plurality of stators 421, 422 each corresponding to a reciprocation mechanism 431, 432. In the embodiment illustrated, the electromagnetic power device comprises first and second stators 421, 422 and first and second reciprocation mechanisms 431, 432. Each stator 421, 422 comprises a permanent magnet 421a, 422a. The stator permanent magnets 421a, 422a are of the same orientation. For example and as illustrated in FIG. 8, both magnets 421a, 422a have N-pole heading down. Each reciprocation mechanism 431, 432 comprises a mover 431a, 432a atop which a permanent magnet 431b, 432b is fixed and opposing the stator permanent 421a, 422a. The mover magnets 431b, 432b are arranged to have the same orientation, which is opposite to that of the stator magnets 421a, 422a. In other words, the stator magnet 421a, 422a and the mover magnet 431b, 432b are always in repulsion with each other.

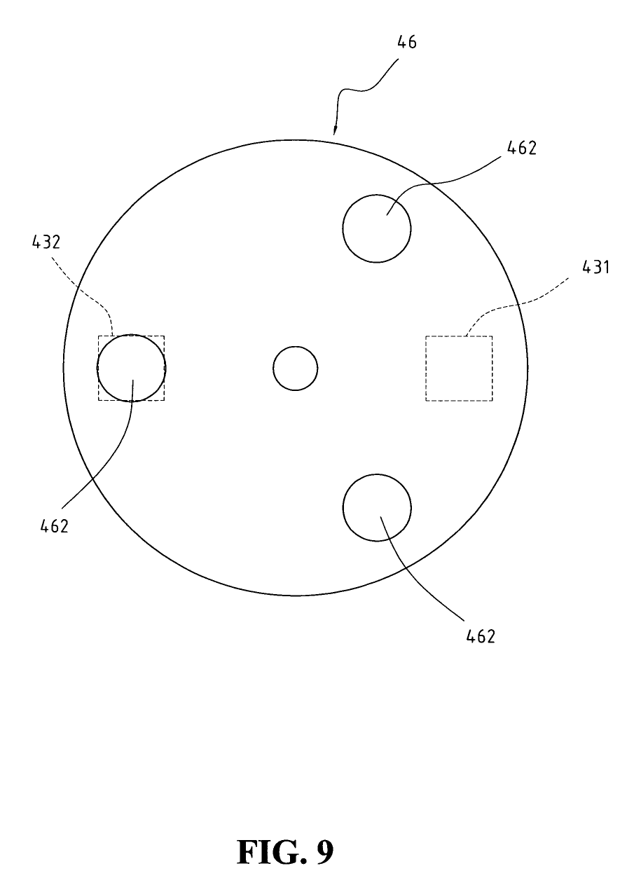

Also referring to FIG. 9, a rotary disc 46 is arranged between the stators 421, 422 and the movers 431a, 432a of the reciprocation mechanisms 431, 432. The rotary disc 46 defines at least one through hole 462 and is driven by for example an electrical motor 461 under the control of a control unit 55 to rotate about an axis located between the reciprocation mechanisms 431, 432 so that the stator magnets 421a, 422a are sequentially exposed to the associated mover magnets 431b, 432b, which induces a repulsive force on the associated movers 431a, 432a. The disc 46 is constructed and made to induce an attractive force on the mover magnets 431b, 432b. Thus, when the stator magnets 421a, 422a are shielded by a non-holed portion of the disc 46, the movers 431a, 432a are attracted to move toward the stators 421, 422 and when the stator magnets 421a, 422a are not shielded, the repulsive forces between the stator magnets 421a, 422a and the mover magnets 431b, 432b force the movers 431a, 432a to move away from the stator 421, 422.

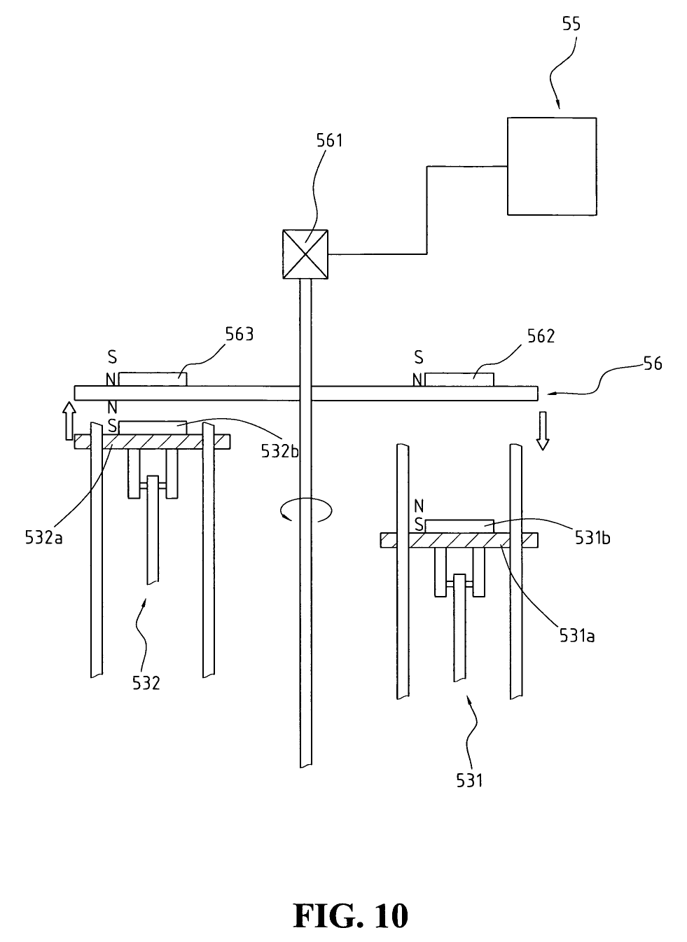

Referring to FIG. 10, which shows an electromagnetic power device constructed in accordance with an eighth embodiment of the present invention, the eighth embodiment comprises a plurality of reciprocation mechanism 531, 532. In the embodiment illustrated, the electromagnetic power device comprises first and second reciprocation mechanisms 531, 532. Each reciprocation mechanism 531, 532 comprises a mover 531a, 532a atop which a permanent magnet 531b, 532b is fixed. The mover magnets 531b, 532b are arranged to have the same orientation. For example, and as illustrated in FIG. 10, the mover magnet 531b, 532b are N-pole heading upwards.

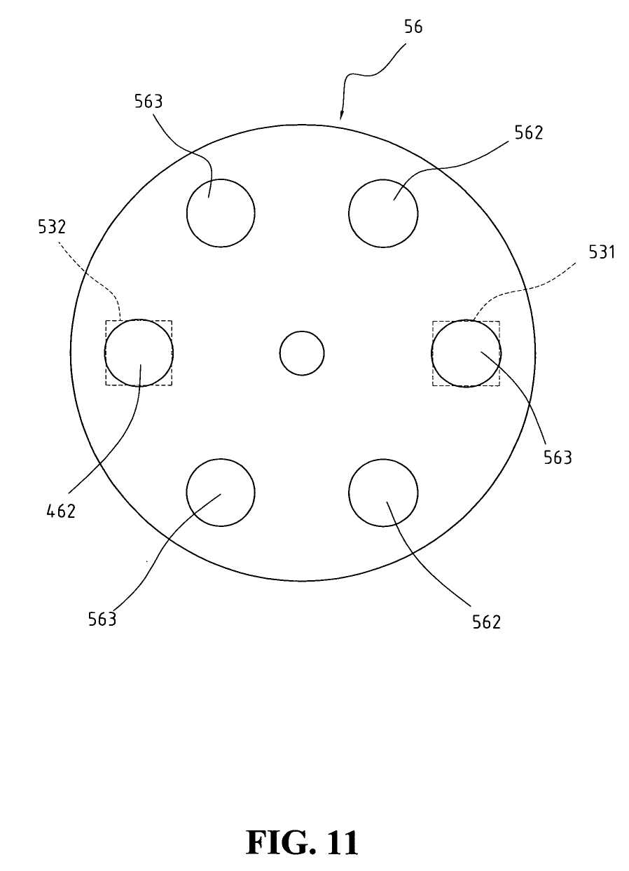

Also referring to FIG. 11, a rotary disc 56 is arranged above the reciprocation mechanisms 531, 532 and is driven by for example an electrical motor 561 under the control of a control unit 56 to rotate about an axis located between the reciprocation mechanisms 531, 532. First and second permanent magnets 562, 563 are mounted to the disc 56 in opposite orientations. For example and as illustrated in FIG. 10, the first magnet 562 is arranged to have the N-pole thereof pointing downward, while the second magnet 563 is S-pole heading downward. The first and second magnets 562, 563 are arranged to correspond to the mover magnets 531b, 532b in position, so that when the disc 56 is rotated, the first and second magnets 562, 563 of the disc 56 sequentially approach and then leaves to the mover magnets 531b, 532b, which induces repulsive and attractive forces alternatively on the movers 531a, 532a to reciprocate the movers 531a, 532a.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electromagnetic power device comprising:
a base forming a guide section;
a stator comprising a coil mounted thereon;
a reciprocation mechanism comprising a mover that is guided by the guide section to reciprocally and linearly move and a link pivoted to the mover, a permanent magnet mounted to the mover and opposing the coil of the stator;
a crankshaft forming a crank section to which the link is rotatably mounted;
a control unit electrically coupled to the coil for supplying electrical power to the coil in a controlled manner whereby the coil generates a variable magnetic field that interacts with a fixed magnetic field of the permanent magnet to move the movers toward/away from the stator, and wherein the linear movement of the mover is converted into rotary motion of the crankshaft by the link.

2. The electromagnetic power device as claimed in claim 1, wherein the guide section forms a channel within and along which the mover is movable by sliding along an inner surface of the channel.

3. The electromagnetic power device as claimed in claim 1, wherein the guide section comprises a plurality of guide posts extending through holes defined in the mover to guide linear movement of the mover.

4. The electromagnetic power device as claimed in claim 3, wherein the guide section comprises two guide posts.

5. The electromagnetic power device as claimed in claim 1, wherein the variable magnetic field generated by the coil is oriented substantially parallel to the linear movement of the mover.

6. The electromagnetic power device as claimed in claim 1 comprising first and second reciprocation mechanisms and the base forming first and second guide sections associated with the first and second reciprocation mechanisms respectively and first and second movers carrying first and second permanent magnets and linearly movable by being guided by the first and second guide sections, the linear movement of the first and second movers being substantially parallel with each other, the stator forming two magnetic pole inducing portions spaced from each other and opposing the first and second permanent magnets respectively.

7. The electromagnetic power device as claimed in claim 6, wherein the first and second permanent magnets are of the same orientation whereby the linear movement of the first and second movers is out of phase.

8. The electromagnetic power device as claimed in claim 6, wherein first and second permanent magnets are of opposite orientations whereby the linear movement of the first and second movers is in phase.

9. The electromagnetic power device as claimed in claim 1 comprising first and second reciprocation mechanisms and the base forming first and second guide sections associated with the first and second reciprocation mechanisms respectively and first and second movers carrying first and second permanent magnets and linearly movable by being guided by the first and second guide sections, wherein the first and second guide sections are arranged on the same plane and on opposite sides of the crankshaft, the crankshaft forming first and second crank sections to which the first and second movers are rotatably coupled by links.

10. The electromagnetic power device as claimed in claim 1 comprising first and second reciprocation mechanisms and the base forming first and second guide sections associated with the first and second reciprocation mechanisms respectively and first and second movers carrying first and second permanent magnets and linearly movable by being guided by the first and second guide sections, the first and second guide sections being inclined with respect to each other.

11. The electromagnetic power device as claimed in claim 1 comprising a plurality of reciprocation mechanisms having links rotatable coupled to crank sections of the crankshaft, the crank sections having angular positions that are selected in accordance with initial positions of the movers.

12. The electromagnetic power device as claimed in claim 1 comprising a plurality of reciprocation mechanisms having links rotatable coupled to crank sections of the crankshaft, the crank sections being angularly spaced around the crankshaft by equal angle.

13. The electromagnetic power device as claimed in claim 1, wherein the stator is changed to provide a fixed magnetic field, while the mover is provided with a coil that is controlled by the control unit to generate a variable magnetic field.

14. The electromagnetic power device as claimed in claim 1, wherein the permanent magnet of the mover is formed by a coil connected to the control unit.

15. The electromagnetic power device as claimed in claim 1, wherein the control unit controls the magnitude of the magnetic field of the stator.

16. An electromagnetic power device comprising:
a base forming a guide section;
a first permanent magnet that generates a fixed magnetic field;
a reciprocation mechanism comprising a mover that is guided by the guide section to reciprocally and linearly move and a link pivoted to the mover, a second permanent magnet mounted to the mover and interact with the first magnet to generate a repulsive force on the mover;
a rotary disc arranged between the mover and the first magnet to interact with the second magnet to induce an attractive force on the mover, the rotary disc defining one opening, the rotary disc being rotatable in a controlled manner to cause the opening to pass through and thus expose the second magnet to the first magnet to alternatively induce repulsive and attractive forces on the mover and thus reciprocally and linear moving the mover along the guide section;
a crankshaft forming a crank section to which the link is rotatably mounted; and
a control unit controlling a driving device for rotating the rotary disc in a controlled manner.

17. An electromagnetic power device comprising:
a base forming a guide section;
a reciprocation mechanism comprising a mover that is guided by the guide section to reciprocally and linearly move and a link pivoted to the mover, a magnet mounted to the mover;
a rotary disc on which first and second magnets having opposite orientations are mounted, the rotary disc being rotatable in a controlled manner to cause the first and second magnets to sequentially pass through and interact with the magnet of the mover to alternatively induce repulsive and attractive forces on the mover and thus reciprocally and linear moving the mover along the guide section;
a crankshaft forming a crank section to which the link that is rotatably mounted; and
a control unit controlling a driving device for rotating the rotary disc in a controlled manner.
